(19) United States
(12) Patent Application Publication
(10) Pub. No.: US 2020/0056928 A1
(43) Pub. Date: Feb. 20, 2020

(54) WEIGHING SYSTEM IN A MAGLEV CONVEYING SYSTEM

(71) Applicant: Laitram, L.L.C., Harahan, LA (US)

(72) Inventors: John F. Landrum, New Orleans, LA (US); Lazlo Kleczewski, Oostzaan (NL)

(21) Appl. No.: 16/610,590

(22) PCT Filed: May 7, 2018
(86) PCT No.: PCT/US2018/031354

§ 371 Date: Nov. 4, 2019

Related U.S. Application Data
(60) Provisional application No. 62/504,022, filed on May 10, 2017.

(51) Int. Cl. G01G 11/04; B65G 54/02; G01G 7/02

(52) U.S. Cl. CPC G01G 11/04; B65G 2203/0258; G01G 7/02; B65G 54/02

(57) ABSTRACT

A magnetic levitation conveying system conveys products on trays and measures the weight of the product without requiring removal of the product or tray. A track below the trays has magnetic levitation coils that generate a magnetic field when energized. The trays include magnets or other levitation elements that interact with the magnetic levitation coils to generate a propulsive levitating force on the tray. A sensor measures a parameter in the system to correlate the parameter with the weight of the conveyed product. The parameter can be a floating height of the tray above the track, an amount of energy necessary to maintain a particular floating height of the tray above the track, a force resulting from accelerating or decelerating the tray, a force required to maintain a desired curve radius when the tray moves around a curve, a force that counteracts an acceleration caused by an incline or other suitable indicator of weight.

### BACKGROUND

The invention relates generally magnetic levitation conveying system and more particularly to magnetic levitation conveying systems capable of weighing conveyed articles.

In some conveying systems, it is desirable to know the weight of articles being conveyed by a conveyor. In magnetic levitation (maglev) conveying systems, weighing of product conveyed on trays requires removal of the product to a separate scale and back onto the tray. Alternatively, the maglev rails could be split to allow the product and tray to be placed on a “standard” weighing system to determine the product weight. Both approaches are complex and provide possible points of contamination.

### SUMMARY

A system and method for determining the weight of a product on a maglev tray measures a parameter and correlates the measured parameter with the weight of the product. The parameter may be the floating height of a tray, an amount of force required to maintain a particular floating height, a centripetal force required to maintain a tray on a curved path, a force to compensate for an acceleration, deceleration, incline or decline. A load cell may also or alternatively be embedded in a maglev tray to measure weight.

According to one aspect, a system for conveying and measuring a weight of a conveyed product, comprises a track having magnetic levitation coils that generate a magnetic field when energized a tray for holding the conveyed product, the tray including magnets or other levitation elements that interact with the magnetic levitation coils to generate a levitating force on the tray and a sensor measuring a parameter in the system and correlating the parameter with the weight of the conveyed product. The parameter can be any suitable indicator of weight.

According to another aspect, a method of measuring the weight of a conveyed product carried on a tray in a maglev system comprises the steps of conveying the tray above a track having energized coils that interact with levitation elements in the tray to generate a propulsive levitating force, measuring a parameter in the maglev system and correlating the parameter to a weight of the conveyed product.

### BRIEF DESCRIPTION OF THE DRAWINGS

These features and aspects of the invention, as well as its advantages, are described in more detail in the following description, appended claims, and accompanying drawings, in which:

FIG. 1 is an isometric view of a maglev conveying system capable of measuring the weight of a conveyed product according to an embodiment of the invention;

FIG. 2 is a side view of the maglev conveying system of FIG. 1, showing the varying floating heights of different loads;

FIG. 3 is a schematic view of a maglev conveying system capable of measuring the weight of a conveyed product according to another embodiment of the invention;

FIG. 4 is an isometric view of a maglev conveying system including embedded load cells for measuring a weight of a conveyed product.

### DETAILED DESCRIPTION

A maglev conveying system determines the weight of a conveyed product while the product remains on a maglev tray and the maglev tray remains floating. The invention will be described below relative to certain illustrative embodiments, though the invention is not limited to the illustrative embodiments.

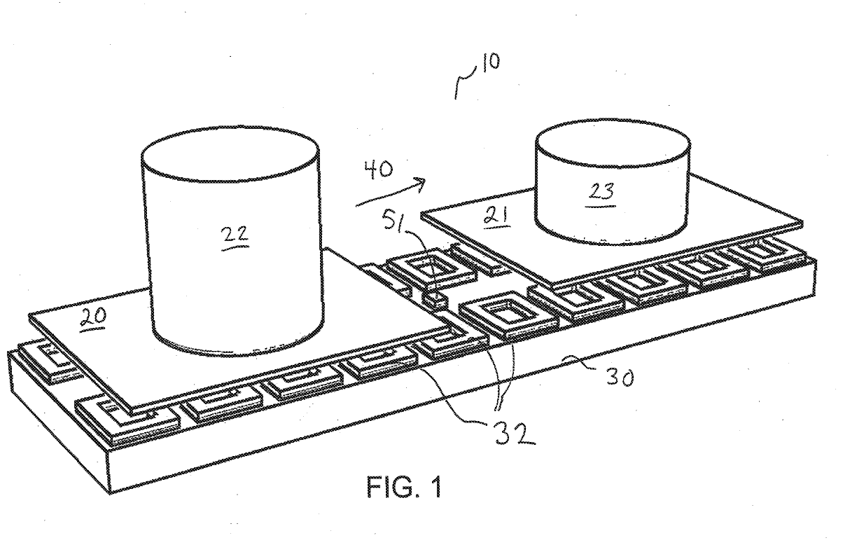

FIG. 1 shows an embodiment of a magnetic levitation (maglev) conveying system capable of weighing a conveyed product. The magnetic levitation system 10 employs conveying trays 20, 21 for carrying products 22, 23. A conveying track 30 contains magnetic levitation coils 32 that generate a magnetic field when a current passes through them. The conveying trays contain levitation elements that interact the energized coils 32 to produce a propulsive levitation force on the trays. In one embodiment, the levitation elements are magnets that interact with the coils 32 to generate a propulsive levitation force. Other suitable means for interacting with the coils to generate a propulsive levitation force can be used. For example, the coils 32 can interact with aluminum to generate eddy currents causing the propulsive levitation force. Alternatively, the propulsive levitation force can be attractive, formed by a c-type shape with a magnet in an opening, whereby the attraction is done from a lower part of the “c” shape. The propulsive levitation force propels the trays 20, 21 and products 22, 23 in a conveying direction 40.

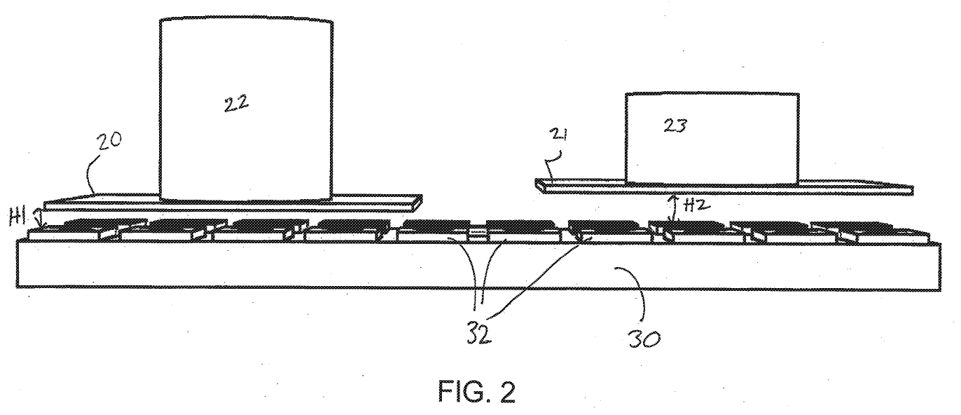

The system may include one or more sensors 51 measuring the floating height of the tray (distance from the tray to a certain point on the track 30) to determine the weight of a conveyed product. As shown in FIG. 2, the sensors 51 measure the floating heights H1, H2 of the trays while the maglev trays are transported with a constant magnet force. Under a constant magnet force, the natural floating height will depend on the load carried by the tray. A heavy load 22 will cause a lower floating height H1, while a lighter weight will cause a higher floating height H2. Therefore, the floating height H of a tray can be used to calculate the weight of a product on the tray using a known float height-weight relationship.

In another embodiment, the maglev system 10 is programmed to transport a maglev tray at a consistent floating height by applying a variable magnet force. The amount of energy required to maintain a consistent floating height will depend on the load carried by the tray. For example, a heavily loaded tray will require more energy to maintain the particular floating height, while a lighter load will require less energy. Therefore, the maglev system 10 can employ a sensor that measures the energy required to maintain a particular floating height and calculate the weight of a conveyed product using a known weight-energy relationship.

In another embodiment, the maglev system 10 can calculate the weight of a product on a tray by measuring forces resulting from accelerating or decelerating a maglev tray. Since force is equal to the mass of the object times the acceleration (F=m*a), the acceleration speeds and resulting force can be measured and used to calculate the weight of the product.

Alternatively, an acceleration force can be created by transporting a product with a constant speed around a curve while measuring the resulting centripetal force required to maintain the desired curve radius.

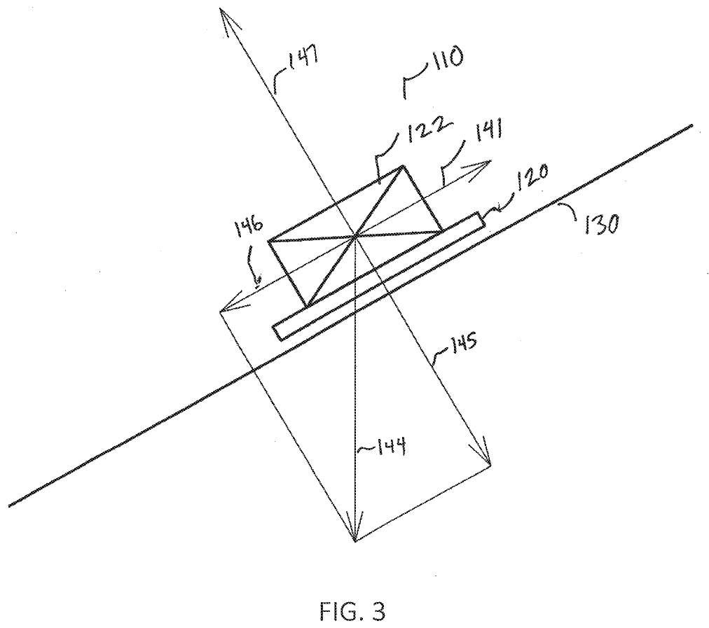

FIG. 3 shows another embodiment of a maglev system 110 capable of measuring a weight of a conveyed product. In the embodiment of FIG. 3, the track 130 with maglev coils for generating a magnetic force is inclined or declined. A maglev tray 120 with a product 122 is transported by magnetic levitation at an incline or decline. With practically zero friction, the tilt angle combined with gravitational pull will create a force vector 144 in the direction of travel that will cause the tray 120 to accelerate. The maglev system 110 is programmed to maintain a constant speed during an incline (or decline) by applying counteracting forces, denoted by vector 141, 147, that counteract the acceleration, while measuring the force required to keep a constant speed. The weight of the product 122 can be calculated based on the incline or decline angle, the gravitational pull, denoted by vector 144 and comprising components 145, 146, the amount of the counteracting force applied 141, and the known weight of the tray 120.

Alternatively, the change in force required to keep the tray 120 floating at a constant distance from the track 130 can also be used to calculate the weight of the product 122 on the tray.

In another embodiment, the maglev tray can be transported in a banked (sideways tilted) position, and the forces required to maintain the constant speed or distance from the track 130 can be used to determine the weight of the conveyed product.

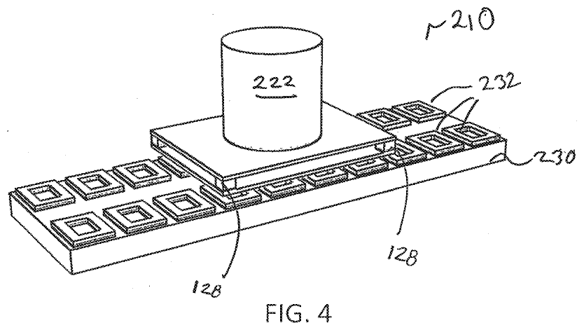

FIG. 4 shows another embodiment of a maglev system 210 including a track 230 and coils 132 for generating a maglev force to convey product that is also capable of measuring the weight of a conveyed product. The maglev system 210 includes at least one load cell 128 embedded in a maglev tray 220. The load cells 128 may be strategically placed, or arranged in an array. The load cells can be read wirelessly to determine the weight of a product on the tray. The load cells can be powered by an on-board power source, such as a battery, or be wirelessly powered through induction, capacitance, light or another source. Data can be transferred from the load cells 128 through any suitable means, such as an embedded CPU and wireless transmitter or other suitable data transfer technology. In another embodiment, the sensor is a load cell containing the magnetic levitation coils, but the invention is not so limited.

Although the weighing system has been described in detail with reference to a few versions, other versions are possible. For example, a combination of weighing solutions can be used to improve the accuracy or resolution of the weight measurement. The scope of the claims is not meant to be limited to the details of the exemplary versions.

What is claimed is:

1. A system for conveying and measuring a weight of a conveyed product, comprising:
a track having magnetic levitation coils that generate a magnetic field when energized;
a tray for holding the conveyed product, the tray including magnets that interact with the magnetic levitation coils to generate a propulsive levitating force on the tray; and
a sensor measuring a parameter in the system and correlating the parameter with the weight of the conveyed product.

2. The system of claim 1, wherein the parameter is the floating height of the tray above the track.

3. The system of claim 1, wherein the parameter is the amount of energy necessary to maintain a particular floating height of the tray above the track.

4. The system of claim 1, wherein the parameter is a force resulting from accelerating or decelerating the tray.

5. The system of claim 1, wherein the parameter is a force required to maintain a desired curve radius when the tray moves around a curve.

6. The system of claim 1, wherein the track is inclined and the parameter is a force that counteracts an acceleration caused by the incline.

7. The system of claim 1, wherein the sensor is a load cell in the tray.

8. The system of claim 1, wherein the sensor is a load cell that holds the magnetic levitation coils.

9. A method of measuring the weight of a conveyed product carried on a tray in a system, comprising the steps of:
conveying the tray above a track having energized coils that interact with levitation elements in the tray to generate a propulsive levitating force;
measuring a parameter in the system; and
correlating the parameter to a weight of the conveyed product.

10. The method of claim 9, wherein the levitation elements are magnets.

11. The system of claim 10, wherein the parameter is the floating height of the tray above the track.

12. The system of claim 10, wherein the parameter is the amount of energy necessary to maintain a particular floating height of the tray above the track.

13. The system of claim 10, wherein the parameter is a force resulting from accelerating or decelerating the tray.

14. The system of claim 10, wherein the parameter is a force required to maintain a desired curve radius when the tray moves around a curve.

15. The system of claim 10, wherein the track is inclined and the parameter is a force that counteracts an acceleration caused by the incline.

16. A system for conveying and measuring a weight of a conveyed product, comprising:
a track having magnetic levitation coils that generate a magnetic field when energized;
a tray for holding the conveyed product, the tray including levitation elements that interact with the magnetic levitation coils to generate a levitating force on the tray; and
a sensor measuring a parameter in the system and correlating the parameter with the weight of the conveyed product.

17. The system of claim 16, wherein the levitation elements comprise magnets.
